(19) United States
(12) Patent Application Publication
(10) Pub. No.: US 2004/0012621 A1
(43) Pub. Date: Jan. 22, 2004

(54) Hyper-media information providing method, hyper-media information providing program and hyper-media information providing apparatus

(76) Inventors: Toshimitsu Kaneko, Kawasaki-shi (JP); Osamu Hori, Yokohama-shi (JP); Takashi Ida, Kawasaki-shi (JP); Nobuyuki Matsumoto, Kawasaki-shi (JP); Takeshi Mita, Yokohama-shi (JP); Koji Yamamota, Yokohama-shi (JP); Koichi Masukura, Kawasaki-shi (JP); Hidenori Takeshima, Ebina-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/619,614

(22) Filed: Jul. 16, 2003

(30) Foreign Application Priority Data
Jul. 17, 2002 (JP) 2002-208784

(51) Int. Cl. G09G 5/00

(52) U.S. Cl. 345/716

(57) ABSTRACT

A hyper-media information providing method comprises acquiring object region information items corresponding to object regions appearing in a motion video and relevant information items concerning the object region information items, reconstructing the object regions corresponding to the object region information items, displaying the reconstructed object regions in list form, selecting an object region from the object regions displayed in list form, and displaying a relevant information item concerning the object region selected.

### CROSS-REFERENCE TO RELATED APPLICATIONS

This application is based upon and claims the benefit of priority from the prior Japanese Patent Application No. 2002-208784, filed Jul. 17, 2002, the entire contents of which are incorporated herein by reference.

### BACKGROUND OF THE INVENTION

1. Field of the Invention

The present invention relates to a hyper-media information providing method, particularly to a hypermedia information providing method to append related information to an image, and a hyper-media information providing apparatus, and a hyper-media information providing program stored in a computer readable medium.

2. Description of the Related Art

Hyper-media define relevance as referred to as a hyperlink between the media such as a motion video, a still video, a voice, a text, and can be referred to one another or referred to from one to the other. Texts and still videos are arranged on, for example, a homepage described by HTML that can be read using Internet. A link is defined everywhere of these texts and still videos. The designation of these links makes relevant data representing a link destination display on a display unit. The text that the link is defined is conventionally underlined, and differs in color from another text, whereby presence of the link can be easily known. If the interest phraseology is directly designated, it is possible to access to relevant information. Therefore, an operation can be performed easily and viscerally.

On the other hand, when the media include a motion video rather than a text and a still video, a link from an object appearing in the motion video to relevant data such as the text or still video explaining the object is defined. It is a representative example of the hyper-media that these relevant data are displayed when an audience designates this object. Then, data (object region data) representing a spatiotemporal region of the object appearing in the motion video, relevant information specifying data for defining relevancy from the object to the relevant information, and relevant information data must be prepared as well as the motion video data.

The object region data can be generated by a mask image stream having values more than a binary, arbitrary shape encoding of MPEG-4 (international standard by an ISO/IEC motion video compression standardization group), or a method of describing a trace of characteristic points of a figure explained in Japanese Patent Laid-Open No. 11-020387.

The relevant information includes a text, a still video, a motion video, a homepage in Internet, an execution program of a computer, etc. The relevant information specifying data is described by a directory having relevant information in a computer and a file name of relevant information, and a URL with relevant information.

The Hyper-media based on mainly a motion video can access relevant information by appointing directly an interest object similarly to an example of a homepage, so that an operation can be performed easily and viscerally. However, there is a problem different from the example of the homepage. When only a motion video is displayed, it cannot be recognized what object has relevant information and what object has no relevant information. As a result, the audience overlooks useful information. On the contrary, even if the object is designated, if the object has no relevant information, nothing can be displayed. On the other hand, viewing of the motion video is disturbed when an object having relevant information is displayed clearly on the image. As thus described, it is a problem in the hyper-media based on mainly the motion video to make relevant information display on a screen so that the relevant information can be easily recognized without disturbing the viewing of the motion video every appearance object.

Another problem is a designation method of an object. The direct designation of an object is easy to understand it viscerally, but it is difficult to indicate a moving object precisely. There is a problem that the object disappears from the screen during a time interval from a time when a user wants information of the object to a time when he or she designates the object, resulting in that the user cannot designate the object. Therefore, the measure that the audience can designate the object precisely on the safe side is necessary.

There is another problem that an interest object is not well viewed for the user because of a small display image when the user views a motion video at a terminal with a small display such as a portable information terminal as referred to as a cellular phone and a PDA.

### BRIEF SUMMARY OF THE INVENTION

It is an object of the invention to provide a hyper-media information providing method that can identify easily an object region attending relevant information from object regions appearing in a motion video and easily acquire the relevant information of the selected object region, a hyper-media information providing apparatus and a hyper-media information providing program stored in a computer readable medium.

According to an aspect of the present invention, there is provided a hyper-media information providing method comprising: acquiring object region information items corresponding to a plurality of object regions appearing in a motion video and relevant information items concerning at least several of the object region information items; reconstructing at least several of the object regions corresponding to the object region information items; displaying the reconstructed object regions in list form; selecting at least one object region from the object regions displayed in list form; and displaying one relevant information item of the relevant information items that concerns the object region selected.

According to another aspect of the present invention, there is provided a hyper-media information providing apparatus comprising: a motion video output unit configured to output a motion video; an object information output unit configured to output object region information items corresponding to a plurality of object regions included in the motion video and relevant information items concerning at least several of the object region information items; a reconstruction unit configured to reconstruct at least several of the object regions corresponding to the object region information items; a display to display the reconstructed object regions in list form; and a selector to select at least one object region from the object regions displayed in list form, the display displaying one relevant information item of the relevant information items that concerns the object region selected.

### BRIEF DESCRIPTION OF THE SEVERAL VIEWS OF THE DRAWING

FIG. 1 is a block diagram showing a configuration of a hyper-media information providing apparatus concerning a first embodiment of the present invention.

FIG. 2 is a flowchart showing a flow of relevant information display processing in the embodiment.

FIG. 3 shows a screen display example in the embodiment.

FIG. 4 is a screen display example in a second embodiment of the present invention.

FIG. 5 is a flowchart showing a flow of a screen display process in the embodiment.

FIG. 6 is another screen display example in the embodiment.

FIG. 7 is a flowchart showing a flow of another screen display screen process in the embodiment.

FIG. 8 is a screen display example in a third embodiment of the present invention.

FIG. 9 is a flowchart showing a flow of a screen display process in the embodiment.

FIG. 10 shows another screen display example in the embodiment.

FIG. 11 is a flowchart showing a flow of another screen display processes in the embodiment.

FIG. 12 shows another screen display example in the embodiment.

FIG. 13 shows a screen display example in a fourth embodiment of the present invention.

FIG. 14 shows an example of a hierarchical structure of an object in the embodiment.

FIG. 15 shows a screen display example in a fifth embodiment of the present invention.

FIG. 16 is a flowchart showing a flow of a screen display process in the embodiment.

FIG. 17 shows another screen display example in the embodiment.

FIG. 18 is a flowchart showing a flow of another screen display process in the embodiment.

FIG. 19 is a flowchart showing a flow of a playback speed control process in a sixth embodiment of the present invention.

FIG. 20 shows a screen display example in a seventh embodiment of the present invention.

FIG. 21 is a flowchart showing a flow of a relevant information display process in the embodiment.

FIG. 22 is an example of data structure of a hyper-media apparatus concerning the first embodiment of the present invention.

FIG. 23 is an example of an object selection screen display in an eighth embodiment of the present invention.

FIG. 24 shows a screen display example in the embodiment.

FIG. 25 is a flowchart showing a flow of relevant information display process in the embodiment.

### DETAILED DESCRIPTION OF THE INVENTION

There will now be described an embodiment of the present invention in conjunction with the accompanying drawings.

FIG. 1 is a diagram of an outline configuration of a hyper-media information providing apparatus concerning the first embodiment according to the present invention.

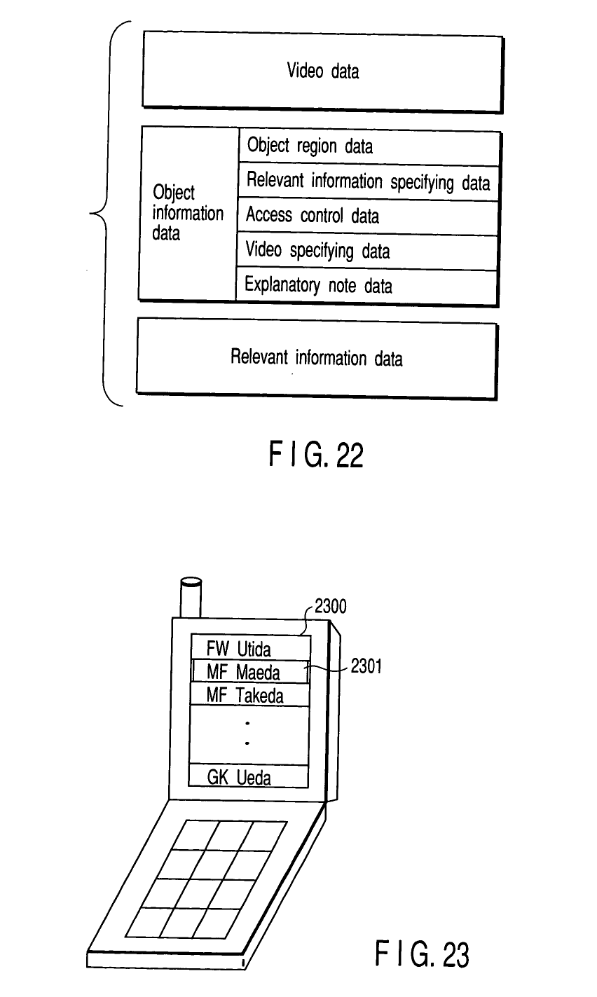

The function of each component will be described referring to FIG. 1. In FIG. 1, motion video data is recorded on a motion video data recording medium 100. Object information data is recorded on an object information data recording medium 101. The object information data includes object region data and relevant information specifying data as shown in FIG. 22, and includes motion video specific data, access control data, annotation data, etc. as necessary.

The motion video specific data is data for permitting to refer to the motion video data from the object information data, the data being described by, for example, a file name and URL of the motion video data. The access control data includes motion video display authorization information indicating a condition for reading the whole of the motion video data or a part thereof, object display authorization information indicating a condition for reading an object appearing in the motion video, and relevant information display authorization information indicating a condition for reading relevant information.

The relevant information data is recorded on a relevant information data recording medium 102. The recording medium 100, 101 and 102 may comprise a hard disk, a laser disk, a semiconductor memory, a magnetic tape, etc. However, it is not necessary that they are always separate mediums. In other words, the motion video data, the object information data, and the relevant information data may be recorded on a single recording medium. Only one of the data may be recorded on another recording medium. The recording mediums 100, 101 and 102 do not have to be provided in local. In other words, they may be put on an accessible location via a network. The motion video playback unit 103 plays back input motion video data. The playback motion video is displayed on a display unit 108 via an image composition unit 106.

The motion video playback unit 103 outputs the number of a frame under playback or a time stamp to an object information management unit 104. The following is a description in using the frame number, but it may be substituted for the time stamp.

The object data management unit 104 reads object information data from the recording medium 101 and manages the whole of the object information. The object data management unit 104 outputs a list of objects existing on the video with respect to the frame number input from the motion video playback unit 103, and outputs the object region of a specific object with respect to the frame number. When a designation object determination unit 107 determines designation of a specific object, it outputs relevant information specifying data to a relevant information playback unit 105 to display relevant information of the object. When the region of the object is displayed, the object region concerning the frame number during playback is output to the image composition unit 106.

The relevant information playback unit 105 reads desired relevant information data from the recording medium 102 based on the relevant information specifying data input from the object data management unit 104, and plays back information according to a data format. For example, HTML, a still video and a motion video are played back. The playback video is displayed on the display unit 108 via the image composition unit 106.

The image composition unit 106 combines the motion video input from the motion video playback unit 103, the object region input from the object data management unit 104 and the relevant information input from the relevant information playback unit 105. A combined result is displayed on the display unit 108. The designation coordinate value input from a designation input 109 is input to the image composition unit 106 to display a cursor according to the coordinate value and change a kind of image composition.

A designation object determination unit 107 determines which object is designated, based on the coordinate data input from the designation input unit 109 and the object region of an object appearing in the playback frame number input from the object data management unit 104. When it is determined that a designated portion is inside the object, an instruction for displaying the relevant information of the object is issued.

The display unit 108 displays a video input from the image composition unit 106. The designation input unit 109 is used for inputting coordinates on the image, and includes a mouse or a touch panel. It may be a wireless remote controller with only a button.

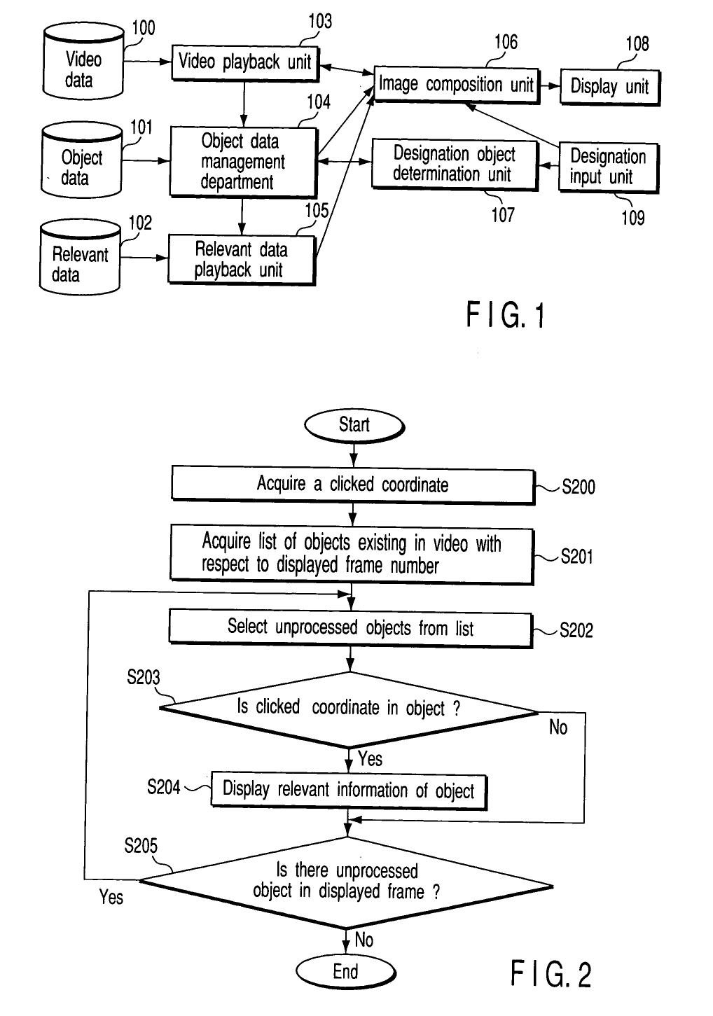

There will now be described a flow of a process for displaying relevant information of the designated object, when an audience specifies a region of an object displayed on a screen with the designation input unit 109. FIG. 2 is a flowchart indicating the flow of this process. The designation input unit 109 assumes a mouse or a touch panel. The object region is designated by a click of the mouse, for example.

In step S200, at first it is computed that the coordinate on a screen that is designated by the designation input unit 109 corresponds to where of the image. The computed result is sent to the designation object determination unit 107.

In step S201, the designation object determination unit 107 requests an object list to the object data management unit 104. The object data management unit 104 acquires a playback frame number from the image regeneration department 103, selects an object appearing in an image with respect to the frame number, draws up an object list as a list of IDs to specify the object, and sends it to the designation object determination unit 107. The selection process of the object is done referring to the top frame number and end frame number that are included in the object region data.

In step S202, the designation object determination unit 107 selects, from the object list, one of the object regions to which the process of step S203 is not still subjected.

In step S203, the designation object determination unit 107 requests to the object data management unit 104 to determine whether or not the coordinate designated in a frame under display is the inside or outside of the selected object. The object data management unit 104 refers to the object region data and the designated coordinate value and determines whether the designated coordinate is inside the object to be processed. As described in Japanese Patent Laid-Open No. 11-020387, when the object region data is parameters that can specify a figure (a rectangle, a polygon, a circle, an oval) in an arbitrary frame, parameters of the figure in a frame number designated are extracted, and the inside/outside determination is done using the parameters. As another example, when the object region data is a binary image stream expressing the inside/outside of the object, this determination process is done by examining a value of a pixel corresponding to the designated coordinate.

The step S204 is a process executed when it is determined in step S203 that the designated coordinate is in the region of the object to be processed. In this case, the relevant information specifying data included in the object information data is sent to the relevant information playback unit 105 and specified relevant information is displayed. When the execution program is designated as relevant information, the program is executed or the designated operation is done.

Step S205 is a divergence process, and determines whether or not an object to which the process of step S203 still is not subjected exists in the object list. When the object exists, the process advances to step S202. When the object does not exist, the process finishes.

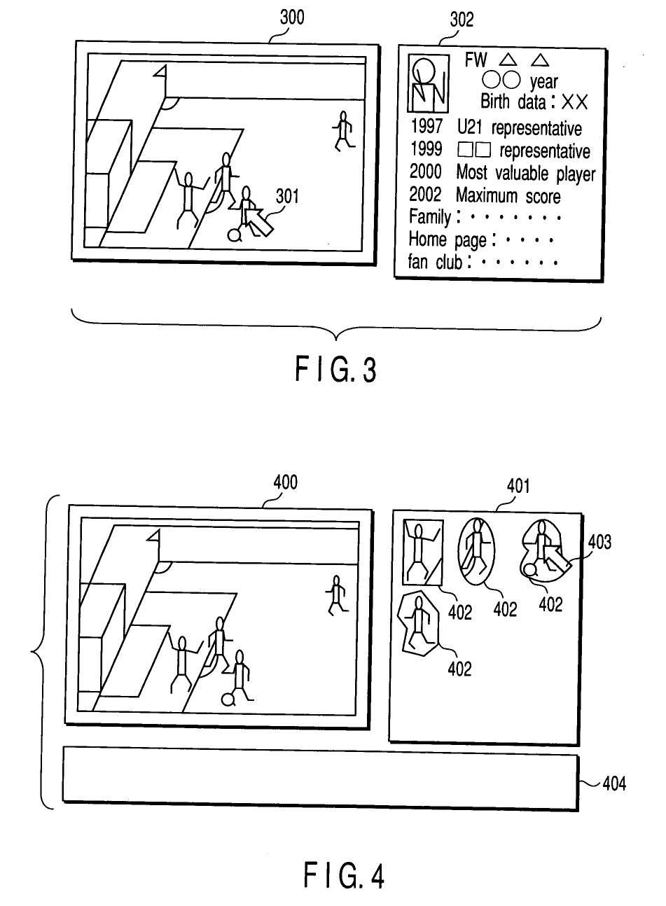

FIG. 3 shows an example that the relevant information of an object appearing in the motion video is displayed as a result that the process of FIG. 2 is done. The motion video display window 300 displays a motion video under playback. When the mouse cursor 301 is clicked in conformity with an appeared object, relevant information of the clicked object is displayed on the relevant information display window 302.

The second embodiment is explained hereinafter. There will now be described how the image composition unit 106 combines images using the motion video from motion video playback unit 103, the object region from the object data management unit 104, the relevant information from the relevant information playback unit 105 and the designation coordinate value from the instruction input unit 109. The image composition unit 106 controls movement of the motion video playback unit 103 such as playback speed at time.

In the present embodiment, the window displaying a motion video is used for clipping an image of an object region and displaying it on another window. FIG. 4 shows an example of images combined by the image composition unit 106. The motion video display window 400 is a screen that plays back the motion video as it is. An appearance object window 401 displays object region data and relevant information. The image regions of objects appearing in the image with respect to a frame number played back on the motion video display window 400 are clipped and displayed on the appearance object window 401 in list form. That is to say, a list of clipped image regions 402 is displayed on the window 401. The image displayed on the window 401 is updated every time the display frame of the motion video display window 400 is changed. In other words, the image clipped from the frame displayed on the motion video display window 400 is always displayed on the window 401.

When the form and position of the object region included in the object region data vary every frame, the shape and (clipped) position of the image region 402 also vary. The object region is scaled vertically and horizontally to a given size to be displayed such that it can easily be viewed.

If an object having object region data is newly displayed on the motion video display window 400, a new object is displayed on the appearance object list window 401 in conformity with the former object. On the contrary, when the object displayed till now disappears from the motion video display window 400, the object is erased from the appearance object list window 401.

When the image displayed on the motion video display window 400 is designated with a designation unit such as a mouse, relevant information is displayed similarly to the first embodiment. However, in the second embodiment, it is possible to display the relevant information on the relevant information window 404 by designating the object region displayed on the appearance object list window 401 with the mouse cursor 403. A difference between the present embodiment and the first embodiment is a point that an appearance object having object region information and relevant information can be known easily. The first embodiment cannot know presence of relevant information till an object is designated, but this second embodiment can easily know it since only an object having relevant information is displayed on the appearance object list window 401. Therefore, it is avoided that although an audience clicked a screen expressly, no relevant information is shown resulting in making him or her despair.

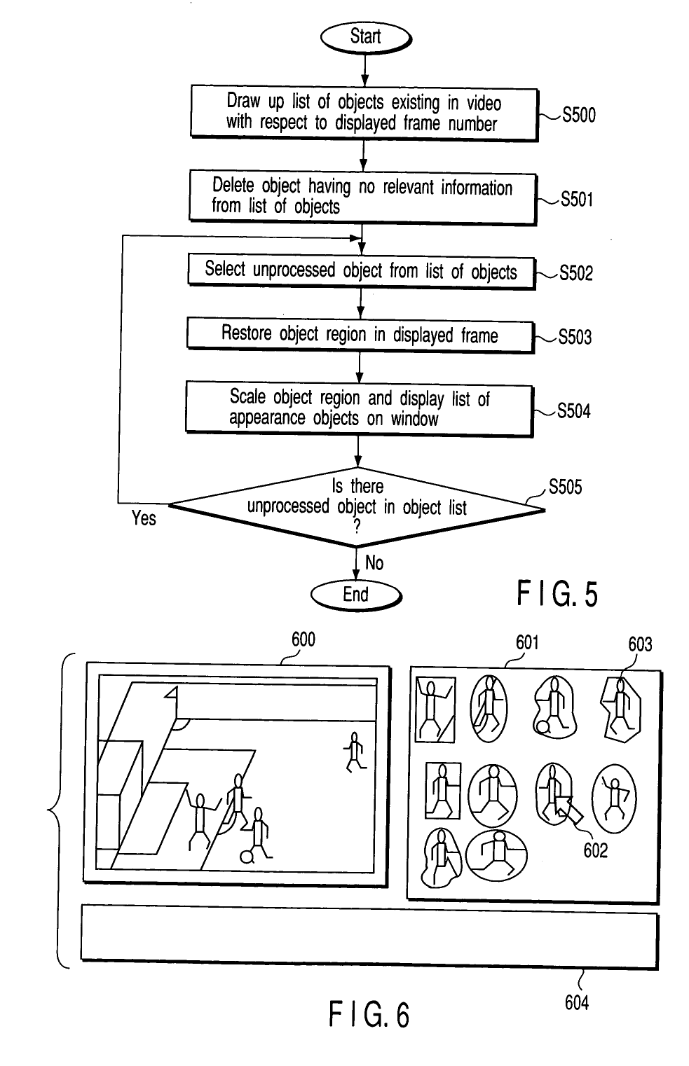

A flow of a process of the second embodiment is explained. FIG. 5 is a flowchart expressing a flow of a process to display an appearance object on the appearance object list window 401. In step S500, an object list existing in a motion video is drawn up with respect to a frame number displaying currently on the motion video display window 400. In step S501, an object having object region data but no relevant information is deleted from an object list. This process may be omitted when the object having no relevant information may be displayed on the appearance object list window 401.

In step S502, the object to which the process of step S503 is not yet subjected is selected from the object list. In step S503, the region of a selected object with respect to the currently displayed frame number is reconstructed from region data. In step S504, only an image in the object region is scaled vertically and horizontally to become a given size and displayed on a given location of the appearance object list window 401. In this time, an object displayed on the previous frame is displayed on the same location as a display location of the previous frame.

In step S505, it is confirmed whether or not the object to which the process in and after step S502 is not yet subjected exists in the object list. If the object exists, the process in and after step 502 is repeated. If there is no such object, the process is finished.

In the process of FIG. 5, since the information that which object is displayed on which position of the appearance object list window 401 can be acquired, when the object displayed on the appearance object list window 401 is designated, a process for displaying the relevant information is obvious.

The modification of the second embodiment can display appearance objects in the entire interval from a start of the motion video to the end. FIG. 6 shows an example of displaying in list form an appearance object list in the entire interval. In this case, the image of the object region 603 displayed on the appearance object list window 601 in the entire interval is regardless of a display frame in the motion video display window 600, and always the same image is displayed on the window 601.

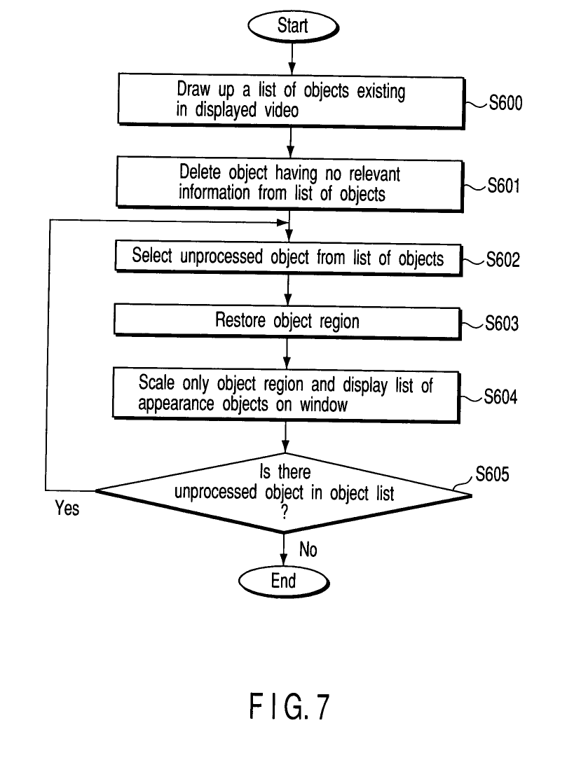

When an object is designated on the appearance object list window 601 with the mouse cursor 602, the relevant information of the object is displayed on a relevant information window 604. The process for displaying objects in the entire interval on the appearance object list window 601 is shown in FIG. 7. Steps S600 and S603 are different from those of FIG. 5. In step S600, given objects of object region data are selected from the entire interval of the motion video to draw up a object list. In step S603, the frame number to be displayed every object is calculated, and the object region in the frame number is reconstructed from the object region data. At least one of the frame number that an object appears, the number of the intermediate frame in the object appearance interval, the number of the frame that an area of an object region is the biggest, the number of the frame that objects are not overlapped, etc. can be selected as the frame number to be displayed.

An example to display a list of appearance objects as an image of objects is explained referring to FIGS. 4 and 6. However, if an annotation such as the name of an object is included in the annotation data of the object information data, a list of annotations may be displayed. In other words, the relevant information of the object corresponding to an annotation is displayed by clicking the annotation.

The second embodiment is described as an example using a mouse as a designation unit. However, in a case using a designation unit having only a button such as a wireless remote controller, it is necessary to use different measures in order to select an object from the appearance object list window 401 of FIG. 4 or the appearance object list window 601 of FIG. 6. The first measure is a method of selecting an object by preparing a button for moving a cursor vertically and horizontally, moving the cursor by operation of the button and pushing down a button having a function to determine an object to be selected. The second measure is a method of selecting an object by assuming one of objects displayed on an appearance object list window as a selection candidate, using as a selection candidate an object that an audience intends to select by pushing down a button having a function to change the selection candidate to the next object, and selecting an object by pushing down a button having a function to determine a selection object last.

A third embodiment using a mouse as a designation unit will be described hereinafter. However, even if a designation unit including only buttons such as a wireless remote controller is used, an operation for selecting an object from a list can be realized by the first or second measure. The third embodiment is an modification of the second embodiment. In the present embodiment, a display method is changed according to a position of a mouse cursor on a screen.

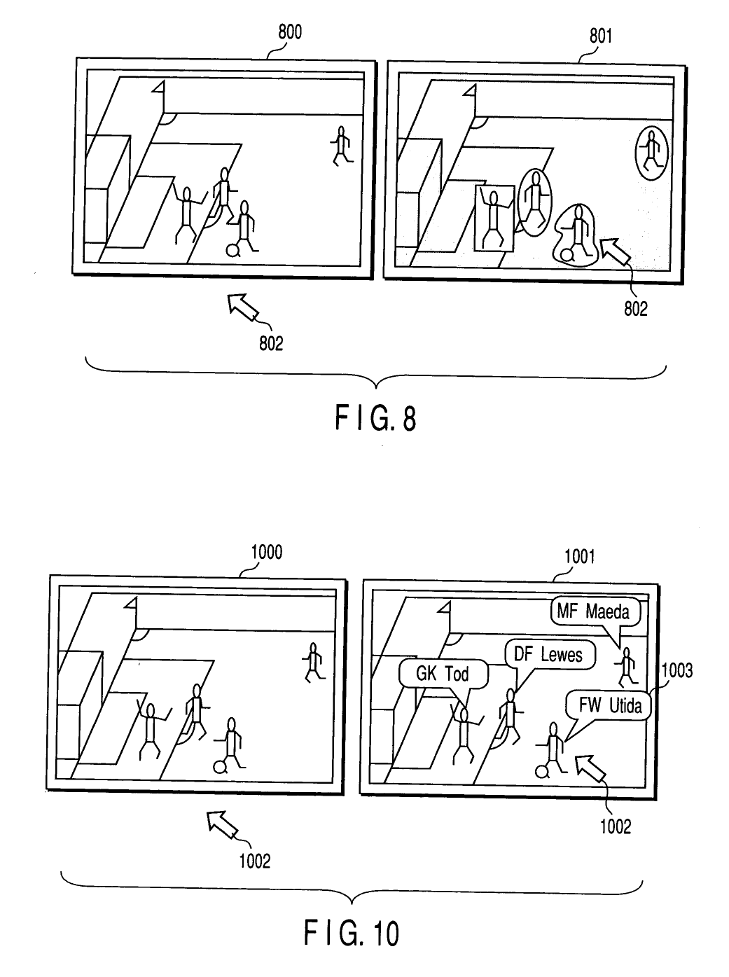

FIG. 8 illustrates an example of images combined with the image composition unit 106. Windows 800 and 801 are display examples of a motion video display window. The two windows 800 and 801 are displayed since display methods of a motion video differ according to a position of a mouse cursor 802. That is to say, the motion video display window 800 is displayed when the mouse cursor 802 is outside the motion video display window, and is used for a normal motion video playback. On the other hand, the motion video display window 801 is displayed, when the mouse cursor 802 is inside the motion video display window. In this example, the region of an object having relevant information in the motion video is usually displayed, the remaining regions are displayed by dropping brightness, for example.

An audience can easily know which object has relevant information by displaying objects as shown in the motion video display window 801. When the audience wants to view a motion video without referring to relevant information, the display is preferably changed to the display of the motion video display window 800. A method of displaying an object region having relevant information and regions aside from it with a change in brightness therebetween as being the motion video display window 801 is described in Japanese Patent Application No. 11-020387. The present embodiment switches two kinds of display methods described above only by moving the mouse cursor 802. Even in the case of either display of the motion video display windows 800 and 801, when the audience clicks the object region, the relevant information is displayed similarly to the first embodiment.

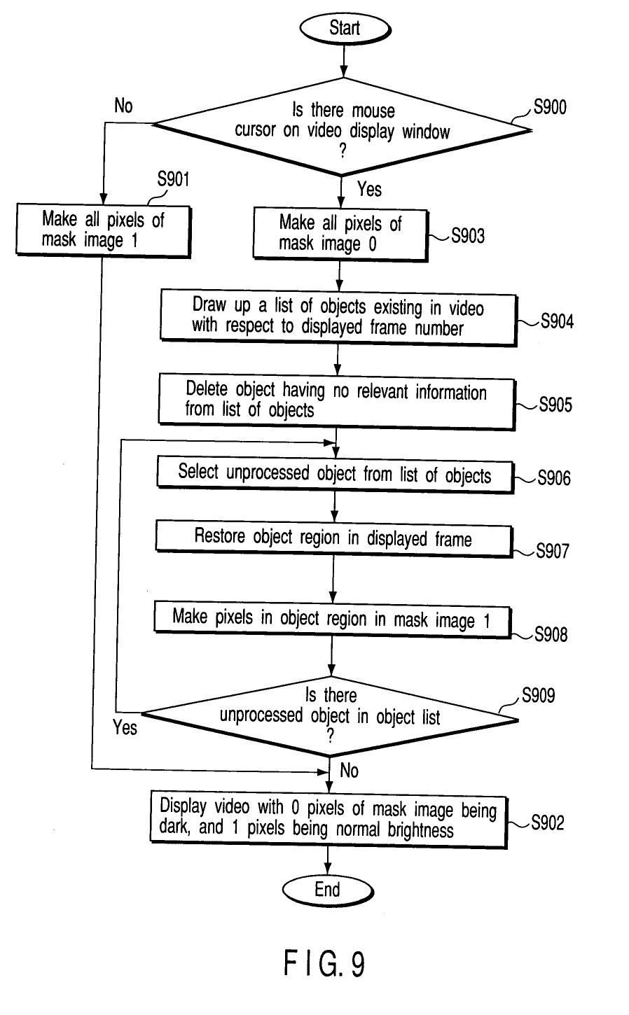

FIG. 9 is a flowchart explaining a routine to realize a display example of the motion video display window shown in FIG. 8. In step S900, it is determined whether the mouse cursor 802 locates in the inside or outside of the motion video display window. When it is inside the motion video display window, the process advances to step 901. When it is in the outside, the process advances to step S903.

In step S901, all pixels of the mask image of the same size as one frame of the motion video are set to “1”. Assumed that a pixel value for a normal motion video display is set to 1 and a pixel value for a motion video display whose brightness is lowered is set to 0. However, if distinction of both motion videos can be made, these values may be freely set.

After step S901 a process of step S902 is done. When the pixel value of the mask image is 0, the motion video is displayed on a motion video display window whose brightness is lowered. When the pixel value of the mask image is 1, the motion video is displayed on the motion video display window normally.

All pixels of mask image are set to 1 when the mouse cursor 802 is located in the outside of the motion video display window. Therefore, the motion video is usually displayed. When the mouse cursor 802 is inside the motion video display window, a step S903 is executed. In step S903, all pixels of the mask image are set to 0. A process using the object list is done in steps S904 to S907. Because this process is completely the same as the process of steps S500-S503 in FIG. 5, explanation is omitted.

In step S908, all the pixels of the mask image corresponding to the position of the object region reconstructed in step S907 are set to 1. Step S909 is the same process as step S505. If an unprocessed object is remained in the object list, steps S906 to S909 are repeated. If the object list empties, the process advances to step S902. When the mouse cursor 802 is inside the motion video display window. Only the region of the object with relevant information is set to 1 on the mask image. Thus, the region aside from it is displayed darkly in step S902.

FIG. 10 shows a display example of a motion video display window that is realized by a process similar to that of FIG. 9. Windows 1000 and 1001 are motion video display windows together. However, a method of displaying the motion video is different between two windows 1000 and 1001 according to a position of the mouse cursor 802 similarly to the case of FIG. 8. Therefore, two windows are displayed.

The motion video display window 1000 shows a display when the mouse cursor 1002 is outside the motion video display window, and is the same as a normal motion video playback. On the other hand, the motion video display window 1001 shows a display when the mouse cursor 1002 is inside the motion video display window. In this example, an annotation about an object is displayed on an object having relevant information in the motion video in a balloon 1003. In this case, the annotation may be any contents such as a name or a characteristic of the object. The annotation is included in the annotation data of the object information data. Even in the case of either display of the motion video display windows 1000 and 1001, when the audience clicks the object region, relevant information is displayed similarly to the first embodiment. In the case that the motion video display window 1001 is displayed, even if a balloon 1003 is clicked, relevant information regarding the object based on the balloon 1003 can be displayed.

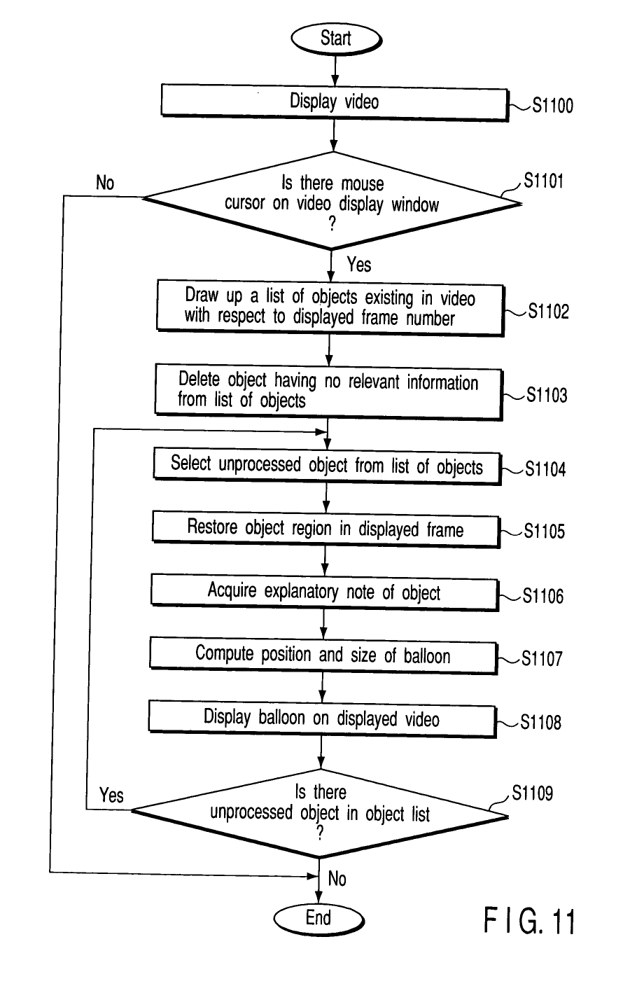

FIG. 11 shows a flowchart to explain a routine to realize the display of FIG. 10. Step S1100 carries out a normal motion video playback display, and indicates a process to display a motion video on the motion video display window. In step S1101, it is determined whether a mouse cursor is inside a motion video display window. If it is inside the motion video display window, the process of step S1102 is executed. If it is outside the motion video display window, the process is finished.

Because the process of steps S1102-S1105 is completely the same as the process of steps S500-S503 in FIG. 5, the explanation is omitted.

In step S1106, an annotation about an object selected in step S1104 is extracted from object information data. The annotation is a text and a still video. In step S1107, the size and position of a balloon to be displayed are calculated using the annotation acquired in step S1106 and the object region reconstructed in step S1105. In step S1108, the balloon is displayed with being overlapped over the motion video displayed on the motion video display window.

Step S1109 is the same process as step S505. If an unprocessed object is remained in an object list, steps S114 to S1109 are repeated. If the object list is not available, the process finishes.

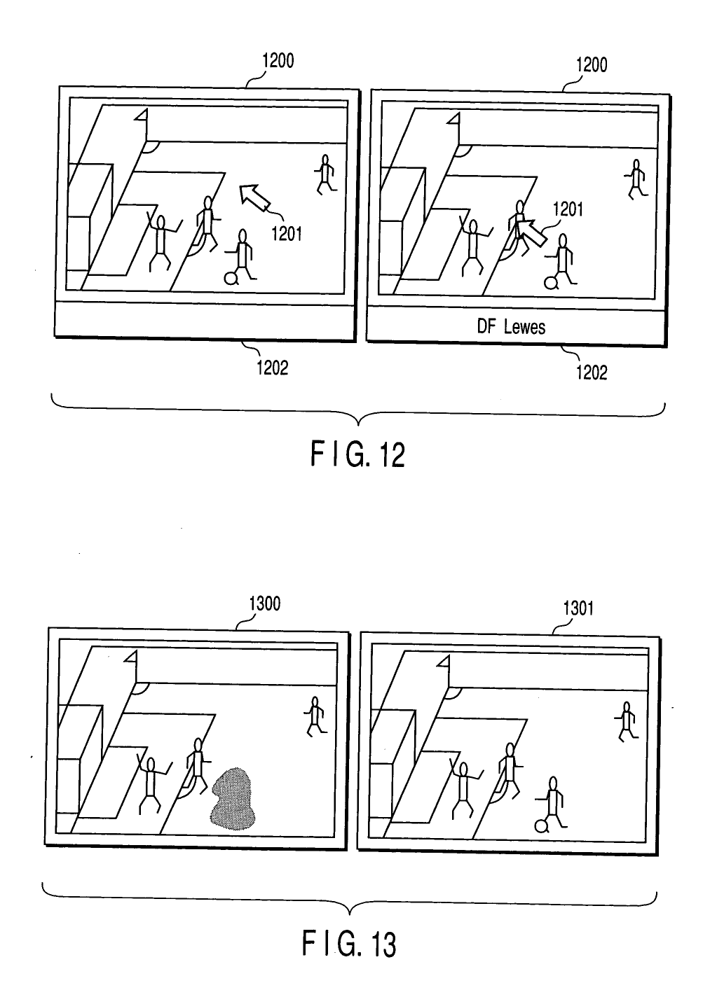

FIG. 12 shows another display example, and an annotation display area 1202 is provided on the motion video display window 1200. The contents displayed on the annotation display area 1202 vary according to the position of the mouse cursor 1201. When the mouse cursor 1201 is not inside any object region, nothing is displayed (left on FIG. 12). When mouse cursor 1201 enters in a certain object region, the annotation of the object is displayed to the annotation display area 1202 (right on FIG. 12).

A process to realize this display resembles a display processing of relevant information as explained in FIG. 2. There are two different points between FIG. 12 and FIG. 2, that is, acquiring a coordinate of the mouse cursor even when be not clicked in step S200, and displaying an annotation rather than relevant information in step S204. The annotation may not be displayed on the annotation display area 1202 but may be displayed on the motion video as a balloon.

The fourth embodiment will be described hereinafter. In this embodiment, a display method is changed by display authorization information.

FIG. 13 is an example of an image displayed on the audience. Window 1300 and 1301 are motion video display windows. However, two motion video display windows are displayed because the motion video display method differs between windows 1300 and 1301 due to display authorization information. The display authorization information is information included in access control data, and describes a condition for displaying a object image. The motion video display window 1300 is a display example when the display condition of the display authorization information is not satisfied, and displays the motion video with a specific object region concealed. On the other hand, the motion video display window 1301 is a display example when the display condition of the display authorization information is satisfied, and displays an image of the object region concealed by the window 1301.

The display condition described in the display authorization information includes age of the audience, a viewing country, pay or free of charge, input of a password, etc. In methods of acquiring information on the audience such as the age of the audience, there are a method of inserting IC card in which data is input every audience, and a method of inputting ID and a password of the audience to specify the audience and referring to personal information input beforehand. Country information is registered in the apparatus beforehand. The pay or free of charge is a condition indicating whether the audience paid an amount of money necessary for viewing an object. When the audience accepts pay of charge, the condition is satisfied by transmitting data to a charging institution through an Internet, etc.

There are a method of painting an area with other colors such as a white, a method of painting an area with circumferential colors, a method of subjecting an area to a mosaic as well as a method of painting an area with a black as the window 1300 of FIG. 13.

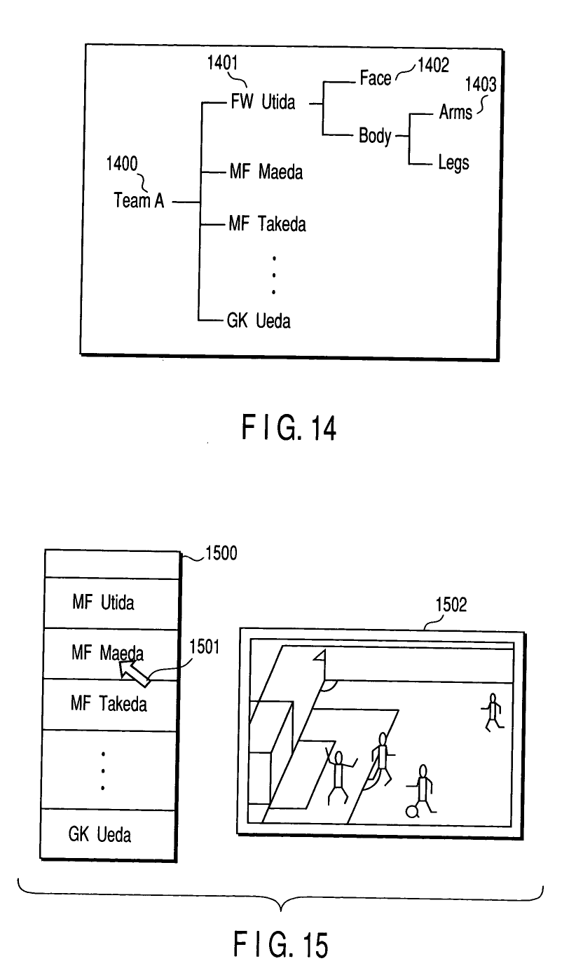

In the case of changing display/non-display of an object according to payment or non-payment of a charge, when a plurality of objects are displayed on the same screen, the audience requires a complicated procedure. In other words, he or she must pay a charge every object. Such a complicated procedure can be settled by giving the object a hierarchical structure. FIG. 14 shows an example of the hierarchical structure of the object. According to this, a soccer team “Team A” is described as the object set of the highest hierarchical layer on the highest layer 1400. Each player of the soccer team “Team A” is described on the second layer 1401 that is lower than the highest layer 1400. A face and a body are described on the third layer 1402 as a part of the player on the second layer. Arms and foots are described on the fourth layer 1403.

In such a hierarchical structure, all the players of the second layer belonging to “Team A” of the highest layer are displayed when the audience pays a charge for viewing the highest layer 1400. On the other hand, when a charge is paid for one or several players of the second layer 1401, only those players are displayed. When a charge is paid only for “a foot” of “FW Uchida” in the fourth layer, only “a foot” of “FW Uchida” is displayed. As thus described, such a hierarchical structure permits displaying at a time the selected object and all the object regions belonging to the selected object. Such the object hierarchical structure can be utilized other than the condition of the display/non-display of the object. For example, display or non-display of the balloon of FIG. 10 can be selected using the hierarchical structure.

As the fifth embodiment, there will now be described a method of playing back a scene in which a desired object appears, using object region data and relevant information specification data. The second embodiment displays relevant information of the object by designation of an audience. In contrast, the present embodiment plays back an appearance scene of the object.

FIG. 15 shows a screen display example that selects an object from a list of annotations regarding an appearance object and plays back the appearance scene of the object. An appearance object annotation list window 1500 is a window for displaying annotations such as names of objects in list form as a list of objects appearing in a motion video. When an annotation displayed on this window is clicked by a mouse cursor 1501, an appearance scene of an object having the annotation is played back on a motion video playback window 1502.

In FIG. 15, the motion video playback window 1502 displays merely a motion video. To clarify an object selected by the audience, a balloon may be displayed on only the selected object as shown in FIG. 10, or a region aside from the selected object may be displayed darkly as shown in FIG. 8.

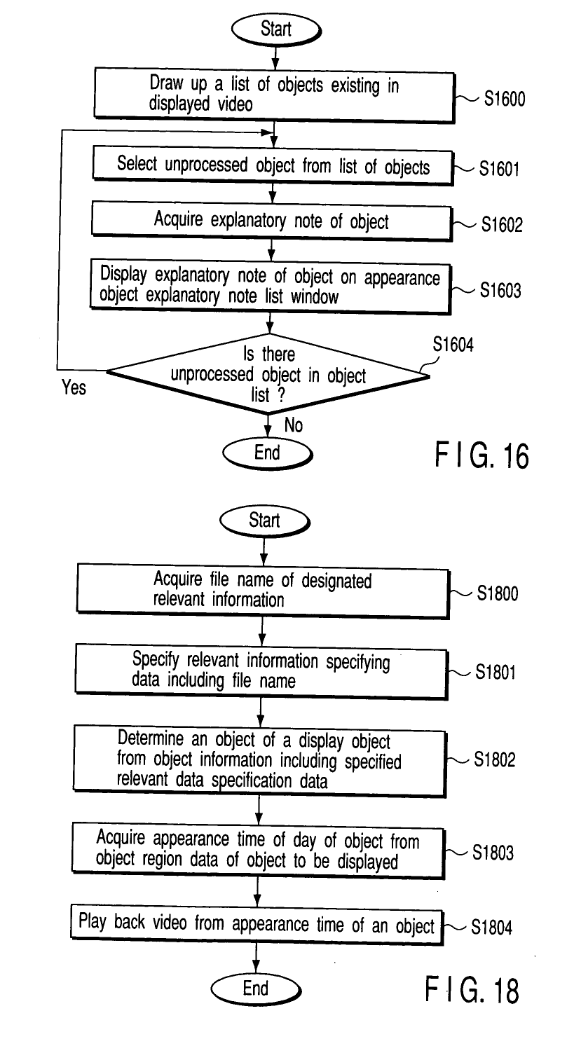

FIG. 16 shows a flowchart explaining a process for performing a display shown in FIG. 15.

In step S1600, all the objects appearing in the motion video are acquired from object information data and a list of objects is made. In step S1601, the object which a process of step S1602 is not yet done is selected from a list of objects.

In step S1602, an annotation is extracted from annotation data corresponding to the selected object. In step S1603, the annotation is displayed on the appearance object annotation list window 1500. In step S1604, it is determined whether the object to which the process of steps S1602 and S1603 is not yet subjected remains in the list of objects. If the determination is YES, the process returns to step S1601. If it is NO, the process is completed.

The function explained referred to FIG. 15 can be realized by substituting the appearance object annotation list window 1500 with an appearance object list window. In other words, the object region is clipped every appearance object as shown in FIG. 6, and the appearance scene of the object is played back on the motion video playback window 1502 when the object region is selected by the audience.

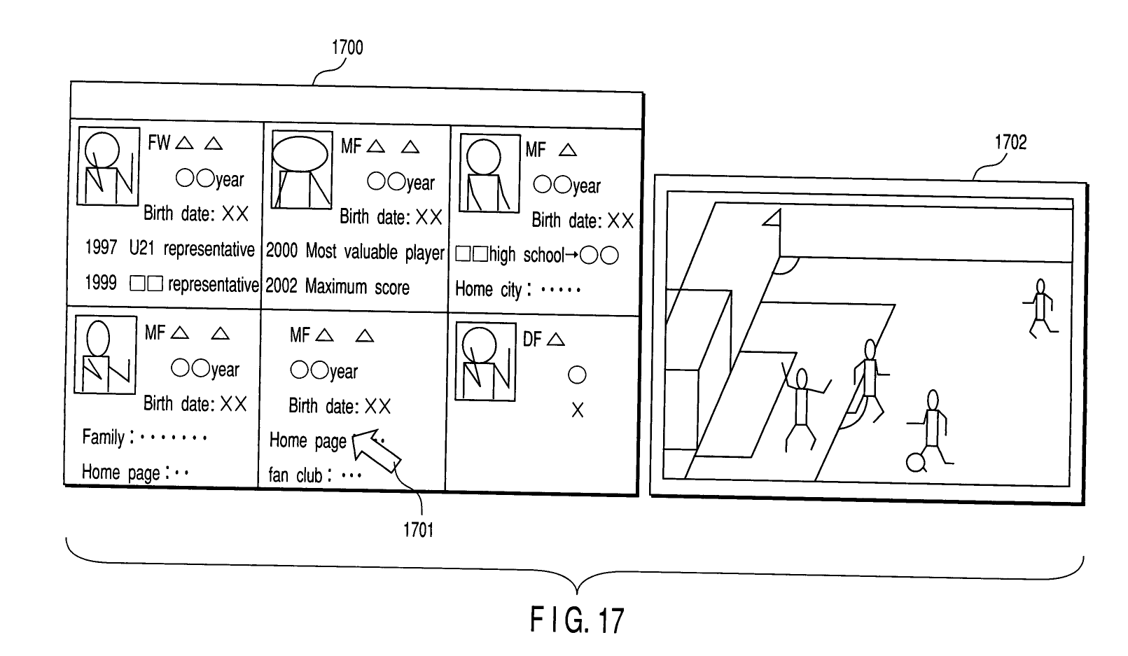

The function explained referred to FIG. 15 can be realized by substituting an appearance object relevant information list window for the appearance object annotation list window 1500. FIG. 17 illustrates a display example of such a case. The relevant information of all objects appearing in the motion video is displayed on an appearance object relevant information list window 1700. When any one in this list is clicked with the mouse cursor 1701, the appearance scene of an object associating with the clicked relevant information is played back on the motion video playback window 1702.

FIG. 18 shows a flow of process for playing back the appearance screen of the object when the relevant information is clicked in FIG. 17. In step S1800, the file name (or URL) of the relevant information specified by the audience is acquired. In step S1801, the relevant information specification data including the file name acquired in step S1800 is searched.

In step S1802, it is specified which is an object including the relevant information specification data searched in step S1801. The specified object is decided as a display object. In step S1803, the appearance time of the object in the motion video is acquired referred to the object region data of an object to be displayed. In step S1804, the object appearance scene is played back on the motion video playback window 1702 from the appearance time acquired in step S1803.

When the relevant information is clicked in FIG. 15, the process for playing back the appearance scene of the object can be realized by substituting the relevant information of FIG. 18 with annotation.

The sixth embodiment is explained hereinafter. There will be described a method of controlling a playback speed of a motion video according to a position of a mouse cursor as a method of making the specification of an object easy for an audience.

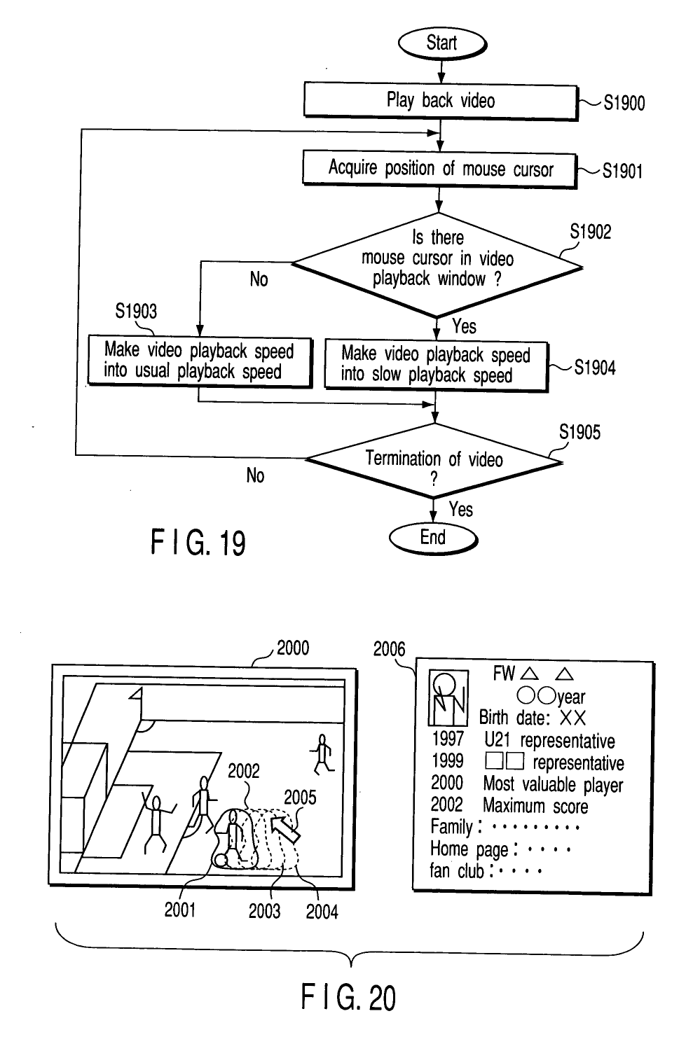

FIG. 19 shows a flowchart of a routine for realizing the sixth embodiment. When a mouse cursor is located outside a motion video playback window by doing the process shown in the figure, an ordinary motion video playback is carried out. When the mouse cursor enters in the motion video playback window, the playback speed of motion video becomes late. Therefore, even if the appearance object moves, the appearance object can easily designated in the motion video playback window. Step S1900 of FIG. 19 is the playback start process of the motion video. In step S1901, information indicating the position where the mouse cursor is currently located is acquired. In step S1902, it is determined whether the position of the mouse cursor acquired in step S1901 is inside the motion video playback window. If the determination is YES, the process advances to step S1903. If it is NO, the process advances to step S1904.

Step S1903 is a process carried out when the mouse cursor is outside the motion video playback window. In this time, the motion video is played back at a normal playback speed. On the other hand, step S1904 is a process carried out when the mouse cursor is inside the motion video playback window, the motion video is played back in a slow playback speed set beforehand. In the extreme case, the playback speed may be set to zero to suspend.

A slow playback speed is not set beforehand, but can be determined according to the movement and size of the object appearing in the motion video. There are a method of calculating a speed (a speed of the object whose movement speed is the fastest or an average speed of the appearing object) representing a movement speed of an object appearing in a currently displayed scene and reducing a slow playback speed according to that the calculated speed is higher, and a method of calculating an area (an area of the smallest object or an area of the whole of the object appearing) representing an area of an object appearing in a currently displayed scene and reducing the slow playback speed according to that the calculated area is smaller.

Step S1905 determines whether the playback of motion video is completed. If the determination is YES, the process is finished. If the determination is NO, the process is returned to step S1901.

The seventh embodiment is explained hereinafter. There is described a method of specifying easily the object region in a motion video by an audience. In other words, there is provided a method of permitting display of relevant information by clicking a position at which an object locates originally even if an object region moves.

FIG. 20 shows a screen display example of the present embodiment. A motion video is displayed on a motion video playback window 2000. In even the above embodiments, it is possible to display relevant information 2006 by moving a mouse cursor 2005 in the inside of a region 2001 in a current frame of a certain appearance object and clicking it. In the present embodiment, the mouse cursor 2005 is outside the region 2001 in the current frame. Even if it is clicked at this position, it is possible to display a relevant information display window 2006. As thus described, the regions that can display the relevant information of the object are an object region 2002 before one frame, an object region 2003 before two frames and an object region 2004 before three frames. In this embodiment, the displayable region is limited by three previous frames. However, the designation region for displaying the relevant information may be selected from any previous frames. Since the object can be designated dating back to the object region before several frames from the current frame, even if the audience designates somewhat late the object region, the relevant information is displayed. Accordingly the designation of the object becomes easy.

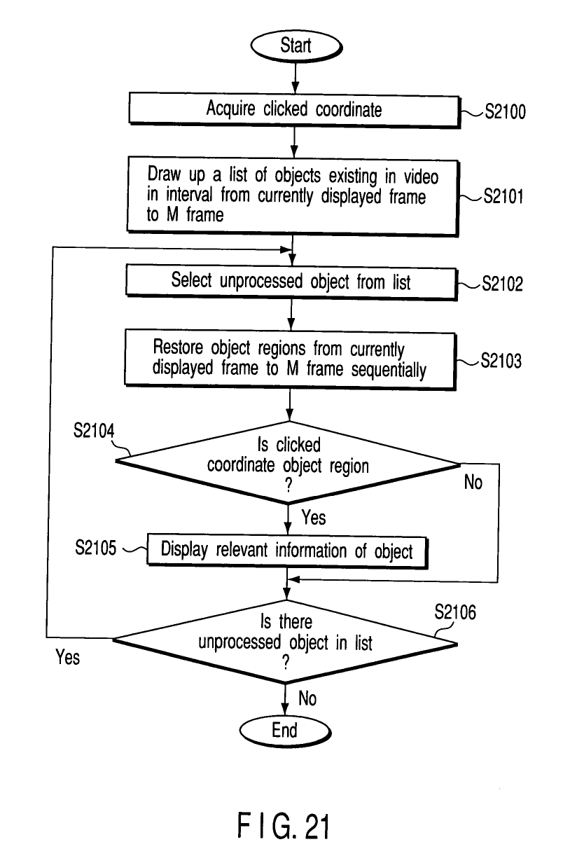

FIG. 21 is a flowchart illustrating a flow of a process for realizing the present embodiment. In FIG. 21, the object regions from the current frame to its M-frame preceding frame are referred to as designation regions for displaying relevant information.

In step S2100, a coordinate clicked by an audience is acquired. In step S2101, a motion video in an interval between the currently displayed frame and its M-frame preceding frame is searched for objects to draw up a list of the objects. This search is done using the frame number of the currently displayed frame and the top frame number and end frame number included in the object region data.

In step S2102, an object to which the process in and after step S2103 is not yet subjected is selected from the list drew up in step S2101. In step S2103, the object region of the object selected in step S2102 in the interval between the currently displayed frame and its M-frame preceding frame is reconstructed. In step S2104, it is determined whether the coordinate acquired in step S2100 is inside any one of a plurality of object regions reconstructed in step S2103. When this determination is YES, the process advances to step S2105. When the determination is NO, the process advances to step S2106.

In step S2105, the relevant information of the object selected in step S2102 is displayed. The location where the relevant information exists is described in the relevant information specification data. In step S2106, it is determined whether the object to which the process of step S2103 is not yet subjected exists in the list made in step S2101. When this determination is YES, the process in and after step S2102 is repeated. When the determination is NO, the process is finished.

The eighth embodiment is explained hereinafter. There is described a method of changing a motion video display mode according to the form of the terminal that an audience uses and the object selected by the audience.

The above embodiments assume that the audience could use a display unit with a large size screen. However, the display unit of a personal digital assistant as referred to as a cellular phone and a PDA spreading rapidly in late years is of a small size. Therefore, it is difficult to realize the above embodiments with the personal digital assistant. In other words, when the motion video that is made to view at home is displayed on the cellular phone or the PDA, it is difficult to understand the displayed motion video due to a small displayed image. The present embodiment is directed to display in an easily viewable form the object which the audience is interested in on a terminal (mainly a portable terminal) with the small display unit. The motion video data and object information data may be stored in a terminal beforehand, and may be transmitted to a terminal from a babe station.

FIG. 23 shows an example of a screen displayed when the audience selects the object that he or she wants to view. In this example, the audience is going to view a motion video with a cellular phone. The audience selects an appearance object that he or she wants to watch in detail from a displayed appearance object list 2300. The appearance object list 2300 can be displayed by a process similar to the process for displaying the appearance object annotation list window 1500 as explained in the fifth embodiment. The images of appearance objects are displayed in list form using the process similar to the process for the appearance object list window 601 that is explained in the second embodiment, other than a method of displaying an annotations list as shown in FIG. 23. In FIG. 23, the audience selects an object 2301. The number of objects to be selected may be one, and plural objects may be selected in order of priority.

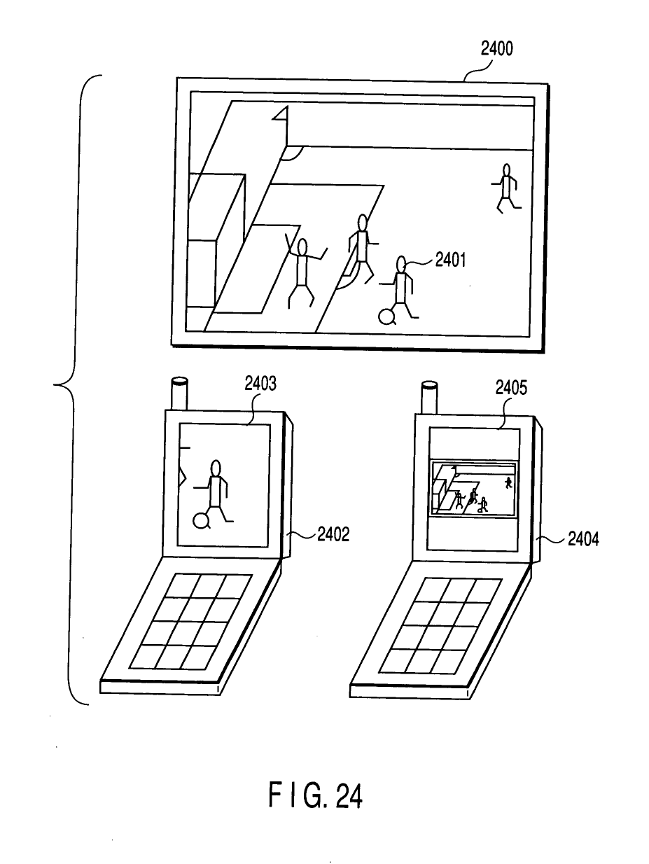

FIG. 24 is a diagram of explaining how motion video is displayed on a terminal with a small display unit. A motion video 2400 is a playback image of the motion video data. In this image, it is assumed that an object 2401 is an object selected by the audience. Then, an image region is clipped and displayed on a cellular phone 2402 with the selected object is located on the center of the image region as shown in the display unit 2403 of the cellular phone. The motion video is reduced in conformity with the size of the display unit of the cellular phone and displayed on the display unit 2405 of the cellular phone 2404. Because the image displayed on the display unit 2405 is small, the audience cannot view in detail the object that he or she wants to view.

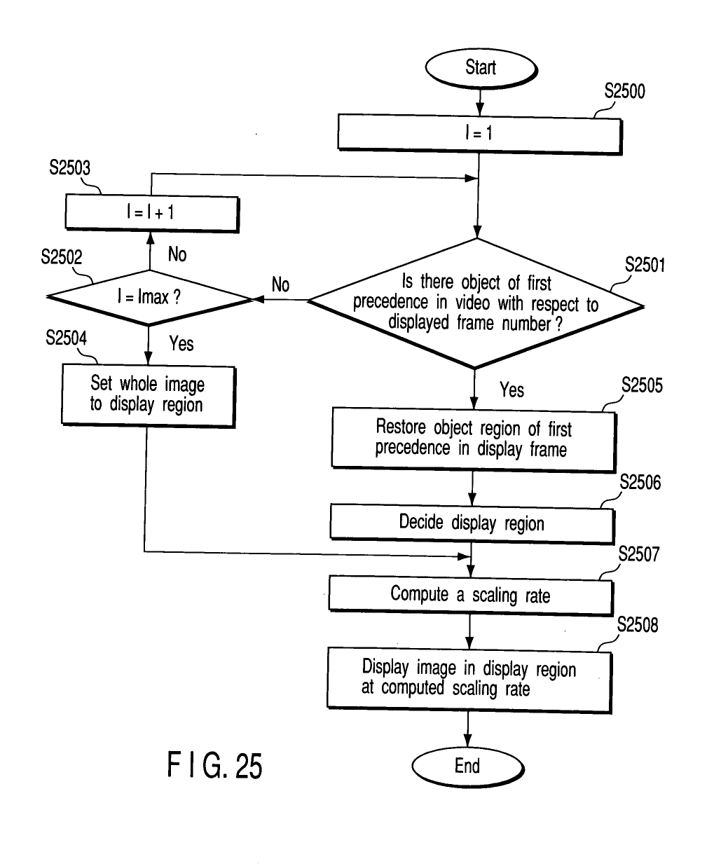

FIG. 25 is a flowchart for explaining a flow of a process for displaying an image as shown in FIG. 24. Assumed that the number of prioritized objects is Imax. If only one object is selected, the value of Imax is 1.

In step S2500, a value of variable I is initialized. In step S2501, it is checked using the object information data whether the object of the priority number I exists in the motion video. If there is the object, the process advances to step S2505. If there is not the object, the process advances to step S2502.

In step S2502, it is checked whether the value of variable I is equal to Imax. If it is equal to Imax, there is no prioritized object in the frame number under displaying. In this case, the process advances to step S2504. When the value of variable I is not equal to Imax, the prioritized objects includes an object that is not checked in step S2501. In this case, after the variable I is updated in step S2503, the step S2501 is repeated again.

When there is no prioritized object, it is done in step S2504 to determine what kind of display is performed. In the present embodiment, in such the case, a display region is set over the whole image. In addition, there may be applied a method of skipping frames to the frame on which the prioritized object appears. In this case, the process in and after step S2500 must be repeated again after the frame is skipped.

Step S2505 is a process executed when the object of the priority number I exists in the motion video. The object of the priority number I is reconstructed from the object information data. Next, the display region decision process of step S2506 is carried out. The simplest display region determination process is a method of using a minimum rectangular area including an object region reconstructed in step S2505 as a display region.

In step S2507, the enlargement/reduction ratio of the display region is calculated using the determined display region and the size of the display unit of the terminal when displaying the display region on the display unit. There is a method of always fixing the enlargement/reduction ratio to 1 time for a simple example of a calculation method. In addition, there is a method of determining the enlargement/reduction ratio so that the display region fits the size of the display unit. In this case, the upper limit and the lower limit of the enlargement/reduction ratio are preferably determined so that the display region is not extremely enlarged or reduced. When the enlargement/reduction ratio severely changes, it is hard to view the display region. For this reasons, the filtering process of the enlargement/reduction ration may be carried out. The calculation of enlargement/reduction ratio may use resolution of the display unit instead of the size of the display unit of the terminal. There is a method of using both of the size and resolution. An example using both of the size and resolution is a method of converting the resolution to a predetermined resolution and then calculating the enlargement/reduction ratio.

In step S2508, the display region determined in step S2506 or step S2504 is enlarged/reduced according to the enlargement/reduction ratio determined in step S2507, and displayed on the display unit. In this case, generally, the center of the display region is matched with the center of the display screen. However, when the display region is at an edge of the motion video, the display range may include the outside of the motion video. In such the case, it is necessary to shift the display range so that the display range does not include the outside of the motion video. Thanks to the above process, the image of one frame can be displayed on the display unit with the size that is easy to view.

It is possible to make a computer execute the process in the embodiments of the present invention as a program.

As discussed above, according to the present invention, it is possible to select an interesting object from a list of objects appearing in a motion video. Therefore, it is possible to know an object having relevant information without disturbing viewing of the motion video. Also, the relevant information can be displayed by selecting it from the list.

Additional advantages and modifications will readily occur to those skilled in the art.

Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A hyper-media information providing method comprising:
acquiring object region information items corresponding to a plurality of object regions appearing in a motion video and relevant information items concerning at least several of the object region information items;
reconstructing at least several of the object regions corresponding to the object region information items;
displaying the reconstructed object regions in list form;
selecting at least one object region from the object regions displayed in list form; and
displaying one relevant information item of the relevant information items that concerns the object region selected.

2. The method according to claim 1, which includes combining the selected object region with the relevant information item corresponding thereto and displaying a composite result of the selected object region and the corresponding relevant information item.

3. The method according to claim 1, wherein displaying the reconstructed object regions includes displaying the reconstructed object regions on a first window of a display unit and displaying the relevant information item includes displaying the relevant information item on a second window of the display unit.

4. The method according to claim 3, wherein displaying the reconstructed object regions includes displaying the reconstructed object regions corresponding to all object regions of the motion video on the first window.

5. A hyper-media information providing method comprising:
acquiring object region information items corresponding to a plurality of object regions appearing in a motion video and relevant information items concerning at least several of the object region information items;
displaying the object regions and a pointer for specifying at least one of the object regions on a display unit;
changing a display state of the object regions having the relevant information items according to a position of the pointer.

6. The method according to claim 5, wherein the changing includes displaying a display area other than the object regions having the relevant information items with the display state different from that of the object regions when the pointer is inside a window displayed on the display unit for displaying the motion video.

7. A hyper-media information providing method comprising:
acquiring object region information items corresponding to a plurality of object regions appearing in a motion video and condition information concerning a display condition of the object regions; and
displaying and concealing selectively the object regions according to the display condition.

8. A hyper-media information providing method comprising:
acquiring object region information items corresponding to a plurality of object regions appearing in a motion video and condition information concerning a display condition of the object regions;
managing objects of the object regions together with features of each of the objects hierarchically with a plurality of layers including a first layer and a second layer lower that the first layer; and
displaying, when displaying the first layer according to the display condition, the second layer.

9. A hyper-media information providing method comprising:
acquiring object region information items corresponding to a plurality of object regions appearing in a motion video and relevant information items concerning at least several of the object regions;
displaying selectively a first list of objects obtained by reconstructing at least several of the object regions corresponding to the object region information items and a second list of the relevant information items of the object regions;
selecting one of the object regions from the first list or one of the relevant information items from the second list;
playing back scenes including the selected one of the object regions or an object region corresponding to the selected one of the relevant information items.

10. A hyper-media information providing method comprising:
acquiring object region information items corresponding to a plurality of object regions appearing in a motion video;
displaying the motion video and a pointer for specifying at least one of the object regions; and
changing a playback speed of the motion video according to a display position of the pointer.

11. A hyper-media information providing method comprising:
acquiring object region information items corresponding to a plurality of object regions appearing in a motion video and relevant information items concerning at least several of the object regions;
displaying the object regions when playing back the motion video;
specifying at least one object region of the object regions appearing in the frames; and
displaying one of the relevant information items that concerns the specified object region even if the object region is specified in an interval between a current frame and its M-frame preceding frame.

12. A hyper-media information providing method comprising:
acquiring object region information items corresponding to a plurality of object regions appearing in a motion video;
designating the object regions selectively; and
determining a display region of the motion video and an enlargement/reduction ratio according to a designated object region and size information of a display unit of a terminal.

13. A hyper-media information providing apparatus comprising:
a motion video output unit configured to output a motion video;
an object information output unit configured to output object region information items corresponding to a plurality of object regions included in the motion video and relevant information items concerning at least several of the object region information items;
a reconstruction unit configured to reconstruct at least several of the object regions corresponding to the object region information items;
a display to display the reconstructed object regions in list form; and
a selector to select at least one object region from the object regions displayed in list form, and
the display displaying one relevant information item of the relevant information items that concerns the object region selected.

14. The apparatus according to claim 13, which includes a composite unit configured to combine the selected object region with the relevant information item corresponding thereto and output a composite result of the selected object region and the corresponding relevant information item to display the composite result on the display.

15 The apparatus according to claim 13, wherein the display displays a first window for displaying the reconstructed object regions and a second window for displaying the relevant information item.

16. The apparatus according to claim 15, wherein the display displays the reconstructed object regions corresponding to all object regions of the motion video on the first window.

17. A hyper-media information providing apparatus comprising:
a motion video output unit configured to output a motion video;
an object region information output unit configured to output object region information items corresponding to a plurality of object regions included in the motion video and relevant information items concerning at least several of the object region information items;
a display to display the object regions and a pointer for specifying at least one of the object regions;
a change unit configured to change a display state of the object regions having the relevant information items according to a position of the pointer.

18. The apparatus according to claim 17, wherein the change unit changes the display state to display a display area other than the object regions having the relevant information items with the display state different from that of the object regions when the pointer is inside a window displayed on the display unit for displaying the motion video.

19. A hyper-media information providing apparatus comprising:
a motion video output unit configured to output a motion video;
an object region information output unit configured to output object region information items corresponding to a plurality of object regions included in the motion video and condition information concerning a display condition of the object regions; and
a display unit configured to display and conceal selectively the object regions according to the display condition.

20. A hyper-media information providing apparatus comprising:
a motion video output unit configured to output a motion video;
an object region information output unit configured to output object region information items corresponding to a plurality of object regions included in the motion video and condition information concerning a display condition of the object regions;
a management unit configured to manage objects of the object regions together with features of each of the objects hierarchically with a plurality of layers including a first layer and a second layer lower that the first layer; and
a display unit configured to display, when displaying the first layer according to the display condition, the second layer also.

21. A hyper-media information providing apparatus comprising:
a motion video output unit configured to output a motion video;
an object region information output unit configured to output object region information items corresponding to a plurality of object regions included in the motion video and relevant information items concerning at least several of the object regions;
a display unit configured to display selectively a first list of objects obtained by reconstructing at least several of the object regions corresponding to the object region information items and a second list of the relevant information items of the object regions;
a selector to select one of the object regions from the first list or one of the relevant information items from the second list;
a playback unit configured to play back scenes including the selected one of the object regions or an object region corresponding to the selected one of the relevant information items.

22. A hyper-media information providing apparatus comprising:
a motion video output unit configured to output a motion video;
an object region information output unit configured to output object region information items corresponding to a plurality of object regions included in the motion video;
a display unit configured to display the motion video and a pointer for specifying at least one of the object regions; and
a change unit configured to change a playback speed of the motion video according to a display position of the pointer.

23. A hyper-media information providing apparatus comprising:
a motion video output unit configured to output a motion video including a plurality of frames;
an object region information output unit configured to output object region information items corresponding to a plurality of object regions included in each of the frames and relevant information items concerning at least several of the object regions;
a display unit configured to display the object regions when playing back the motion video;
a specifying unit configured to specify at least one object region of the object regions included in each of the frames of the motion video; and
displaying one of the relevant information items that concerns the specified object region even if the object region is specified in an interval between a current frame and its M-frame preceding frame.

24. A hyper-media information providing apparatus comprising:
a motion video output unit configured to output a motion video;
an object region information unit configured to output object region information items corresponding to a plurality of object regions included in the motion video;
a designation unit configured to designate the object regions selectively; and
a determination unit configured to determine a display region of the motion video and an enlargement/reduction ratio according to a designated object region and size information of a display unit of a terminal.

25. A hyper-media information providing program stored in a computer readable medium, the program comprising:
means for instructing a computer to acquire object region information items corresponding to a plurality of object regions appearing in a motion video and relevant information items concerning at least several of the object region information items;
means for instructing the computer to reconstruct at least several of the object regions corresponding to the object region information items;
means for instructing the computer to display the reconstructed object regions in list form;
means for instructing the computer to select at least one object region from the object regions displayed in list form; and
means for instructing the computer to display one relevant information item of the relevant information items that concerns the object region selected.
